(19) United States
(12) Patent Application Publication
(10) Pub. No.: US 2013/0126491 A1
(43) Pub. Date: May 23, 2013

(54) Method and Device for Machining a Workpiece by Means of a Laser

(71) Applicants: Thomas Veit, Mintraching (DE); Ruth Janssen, Seubersdorf (DE)

(72) Inventors: Thomas Veit, Mintraching (DE); Ruth Janssen, Seubersdorf (DE)

(73) Assignee: OSRAM Opto Semiconductors GmbH, Regensburg (DE)

(21) Appl. No.: 13/643,064

(22) PCT Filed: Apr. 11, 2011
(86) PCT No.: PCT/EP11/55623

§ 371 Date: Feb. 1, 2013

(30) Foreign Application Priority Data
Apr. 23, 2010 (DE) 10 2010 018 032.7

(51) Int. Cl. B23K 26/02; H01L 21/304

(52) U.S. Cl. CPC B23K 26/02
USPC 219/121.82

(57) ABSTRACT

The invention relates to a method for machining a workpiece by means of a laser, wherein a laser beam of the laser irradiates the workpiece, the laser beam remains stationary and the workpiece is moved when a central region of the workpiece is irradiated, and the laser beam and the workpiece are moved at least intermittently when an edge region of the workpiece is irradiated.

This patent application is a national phase filing under section 371 of PCT/EP2011/055623, filed Apr. 11, 2011, which claims the priority of German patent application 10 2010 018 032.7, filed Apr. 23, 2010, each of which is incorporated herein by reference in its entirety.

### TECHNICAL FIELD

A method for machining a workpiece by means of a laser is specified. Furthermore, a device for machining a workpiece by means of a laser is specified.

### SUMMARY OF THE INVENTION

In accordance with at least one embodiment of the method for machining a workpiece by means of a laser, a workpiece is irradiated by a laser beam of the laser. The energy of the laser beam is preferably at least partly absorbed by the workpiece. As a result, heat can arise in or at the workpiece, which leads to a material change in the region of the irradiated area. By way of example, material can be removed from the workpiece and/or changed by means of the laser beam. That is to say that a material removal or a material change can be carried out at the workpiece by means of the laser beam. By way of example, the workpiece is partly or completely severed by means of the laser and/or parts of the workpiece are detached from the workpiece by means of the laser beam.

It should be pointed out at this juncture that the present method is not restricted to the use of a single laser beam. Rather, a multiplicity of laser beams can also be used. A multiplicity of laser beams can be generated from a single laser beam, for example, by means of a beam splitter (DOE).

In accordance with at least one embodiment of the method, the laser beam remains stationary during the irradiation of a central region of the workpiece and the workpiece is moved relative to the laser beam. In other words, as a result of a movement of the workpiece relative to the laser beam, the laser beam is guided along the direction of movement over the workpiece. The laser beam itself is not moved in the process. Thus, if the movement of the workpiece were stopped, then the laser beam would always irradiate the same region of the workpiece. The laser beam irradiates the workpiece for example from a top side of the workpiece. In the plan view of the irradiated surface of the workpiece, the central region of the workpiece is then given by a segment of the workpiece which does not comprise an edge or a margin of the workpiece. The central region is embodied in circular or rectangular fashion, for example. The central region extends over the entire top side of the workpiece as far as a predeterminable distance from the edge of the workpiece. By way of example, the central region can occupy at least 80% of the area at the top side of the workpiece, and the remaining at most 20% then forms the edge region of the workpiece, which comprises the edge of the workpiece. In this case, the central region comprises, for example, the geometric centroid of the area at the irradiated top side of the workpiece, whereas the edge region does not.

In accordance with at least one embodiment of the method, during the irradiation of the edge region of the workpiece, the laser beam and the workpiece are moved at least intermittently. That is to say that during the irradiation of the edge region, the laser beam no longer remains stationary, but rather is actively guided over the workpiece in the edge region. In this case, the workpiece itself is also moved at least intermittently. The relative movement and also the relative velocity between laser beam and workpiece then correspondingly result from the movements and velocities of the laser beam and workpiece.

By way of example, the irradiated area of the workpiece can be guided by means of the movement of the laser beam in an opposite direction with respect to the movement of the workpiece. The relative velocity at which the workpiece is then moved relative to the laser beam results, for example, by addition of the two velocity vectors, that is to say the velocity of the laser beam and the velocity of the workpiece.

In accordance with at least one embodiment of the method for machining a workpiece by means of a laser, a laser beam of the laser irradiates the workpiece. During the irradiation of a central region of the workpiece, the laser beam remains stationary and the workpiece is moved. During an irradiation of an edge region of the workpiece, the laser beam and the workpiece are moved at least intermittently. In this case, it is also possible for both the laser beam and the workpiece to be moved during the entire duration of the irradiation of the edge region. The velocity at which the workpiece is moved and the velocity at which the laser beam is moved can vary in each case.

The laser beam can in this case be moved to just before the edge of the edge region, exactly as far as the edge of the edge region or beyond the edge region.

The method described here in this case addresses, inter alia, the following problem. In a device for the laser machining of a workpiece, the positioning of the laser radiation relative to the workpiece can be performed in at least two ways. Firstly, the laser beam can be guided actively over the workpiece using a scanner, for example. In this case, the laser beam is moved relative to the stationary workpiece for example by the deflection of the laser radiation via minors. Secondly, a movable displacing table having positioning axes can be used, the workpiece being fixed on said table. In this case, a movable displacing table has the advantage that it has a larger machining space than a scanner and the location of the irradiation by the laser can be set significantly more accurately than when a scanner is used. By contrast, a scanner can work faster, that is to say that, in particular, the positioning of the laser beam relative to the workpiece can be performed faster.

In both methods, the total process time is composed of the machining time of the workpiece by the laser beam and the reversal time required for changing the direction of laser beam and/or workpiece. Where a displacing table is used, the reversal time is crucially determined by the fact that the displacing table has to be decelerated toward the end of a, for example rectilinear, machining path, halted and accelerated again for example in the opposite direction of the machining path. In the period of decelerating, halting and accelerating, the workpiece cannot be machined by the laser radiation. In this case, the reversal time contributes a significant proportion to the total process time. Decelerating, halting and reaccelerating during laser machining is not possible since the velocity at which the laser beam is guided over the workpiece would change as a result, that is to say that the process parameters for the laser machining would change. If the laser beam moves over the workpiece more slowly, for example, then every irradiated location is irradiated for longer than if the laser beam moves faster, which could lead, for example, to an increased material removal and/or to an impermissibly high heating of the workpiece.

The method described here is now based on the concept, inter alia, that in regions in which a change in the movement of the workpiece, that is to say for example a change in the velocity and/or in the direction of movement, has to be performed, designated here as edge regions, in addition to the movement of the workpiece the laser beam is moved in order to balance and compensate for the change. By way of example, during the decelerating time of the displacing table and thus of the workpiece, the laser radiation is actively guided over the workpiece for example in the opposite direction with respect to the direction of movement of the workpiece, such that process parameters such as the relative velocity between laser beam and workpiece remain substantially identical. Advantageously, for example, before reaching the edge, that is to say the margin of the workpiece, it is possible to begin decelerating the workpiece and nevertheless to continue the material machining further. The same applies to accelerating the workpiece for example after the change in direction of the movement of the workpiece.

In accordance with at least one embodiment, the relative velocity between laser beam and workpiece during the irradiation of the edge region is at least intermittently equal to the relative velocity between laser beam and workpiece during the irradiation of the central region, that is to say when the laser beam remains stationary. Overall, it is thus possible for the relative velocity between laser beam and workpiece in one direction to be constant or substantially constant. In this case, the relative velocities can deviate slightly from one another, for example the deviation in the edge region is at most 10% of the maximum relative velocity between laser beam and workpiece in the central region.

In accordance with at least one embodiment of the method, the laser is operated in pulsed fashion. That is to say that the laser beam does not impinge continuously on the workpiece, rather the workpiece is irradiated by the laser beam with a sequence of short pulses. In accordance with at least one embodiment, the duration of the pulses, that is to say the pulse length, is in this case at most 100 nanoseconds. That is to say that the laser is a nanosecond laser.

In accordance with at least one embodiment of the method, the laser is operated in pulsed fashion and the duration of the pulses is at most 100 picoseconds. That is to say that the laser is then a picosecond laser. In the case of such a picosecond laser, the above-described problem of the reversal times when changing direction is particularly serious since the material removal per pulse, on account of the shorter pulse length, is significantly smaller than in the case of a nanosecond laser. Owing to that, very many passes and thus changes of direction are necessary for example for severing the workpiece.

In accordance with at least one embodiment of the method, material of the workpiece is removed in places during the machining of the workpiece. The material can be removed by ablation, for example. Particularly when a nanosecond laser is used, the workpiece is in this case heated in the region of the irradiation by the laser to such a great extent that a plasma arises and the removed material vaporizes. The method can then be used for targeted removal of material of the workpiece.

In accordance with at least one embodiment of the method, during the machining of the workpiece, the workpiece is severed into at least two parts along a line running along the relative movement between laser beam and workpiece. That is to say that the method is a laser separating process. The laser separation can be effected by melting the material of the workpiece. This is the case for example when a nanosecond laser is used. When a picosecond laser is used, the material, instead of being melted, can be removed by the laser radiation by means of ablation. This reduces the production of slag along the severing region in contrast to melting, as a result of which the produced segments of the workpiece have a particularly good quality of the edges produced by the irradiation.

During the laser separating process it is also possible that along the line only a material removal over a certain depth, for example 30 μm, of the workpiece is effected and the complete separation of the workpiece along the line takes place at a later point in time, for example by means of breaking.

In accordance with at least one embodiment of the method, during the machining of the workpiece, the workpiece is severed into at least two parts along a plane that the laser beam intersects at least in the extension thereof. “Intersects at least in the extension thereof” means that the laser beam need not intersect the plane, but rather is absorbed for example above the plane, that is to say before reaching the plane. By means of the method, for example, two material layers of the workpiece can be separated from one another in such a way that the separated material layers are substantially completely maintained, for example. In this case, the laser radiation can be absorbed at the interface between the two material layers or in the vicinity of the interface. The absorption of the laser radiation induces a material decomposition, that is to say a change in the material composition in the workpiece, which can lead to a weakening or release of the connection between the two material layers. The method is then therefore a so-called laser lift-off process.

In accordance with at least one embodiment of the method, the workpiece comprises an epitaxially grown layer sequence, wherein the layer sequence comprises at least one optoelectronic, active layer. By way of example, the active layer is a layer provided for generating radiation or for detecting radiation. The workpiece can then be a wafer, for example, which can be divided into a multiplicity of individual optoelectronic semiconductor chips. The optoelectronic semiconductor chips are, for example, laser diode chips, light emitting diode chips, or photodiode chips.

In accordance with at least one embodiment of the method, during the machining, a substrate is detached from the epitaxially grown layer sequence. The substrate can be a growth substrate, for example. The workpiece is, for example, severed into two parts, namely the growth substrate and the epitaxially grown layer sequence, along a plane lying in the region of the interface between growth substrate and epitaxially grown layer sequence.

Furthermore, a device for machining a workpiece is specified. The device is preferably suitable and designed for carrying out a method described here. That is to say that all features described for the method are also disclosed for the device, and vice versa.

In accordance with at least one embodiment of the device, the device comprises a movable displacing table, to the top side of which the workpiece is fixed. In this case, the workpiece is preferably mechanically nondestructively releasable from the displacing table. The workpiece is fixed to the displacing table in such a way that a movement of the displacing table is transferred to the workpiece.

The device furthermore comprises a laser, which is designed to generate a laser beam that irradiates the workpiece. That is to say that the laser beam of the laser is directed onto the workpiece in such a way that the workpiece can be influenced by the laser beam. By way of example, the workpiece can absorb at least part of the energy of the laser beam. The device furthermore comprises an optical device, which is suitable for moving the laser beam relative to the workpiece. By means of the optical device, the laser beam can be guided at least in a specific region, for example the edge region, over the top side of the workpiece facing the laser beam.

The device furthermore comprises a control device, which is designed to control the movement of laser beam and displacing table relative to one another. For this purpose, the control device can comprise for example a microprocessor or a computer, such as a PC.

In accordance with at least one embodiment of the control device, the control device is designed to control the movement of laser beam and displacing table in such a way that during the irradiation of a central region of the workpiece, the laser beam remains stationary and the workpiece is moved, and during the irradiation of an edge region of the workpiece, the laser beam and the workpiece are moved at least intermittently.

In accordance with at least one embodiment of the device, the optical device for moving the laser beam is a scanner, which comprises at least one mirror by which the laser beam can be deflected. In this case, the minor is preferably embodied in movable fashion, such that the laser beam is moved over the workpiece as a result of the movement of the mirror. As an alternative to a scanner, the optical device can also comprise an acousto-optical deflector, which is likewise suitable for moving the laser radiation over the workpiece.

### BRIEF DESCRIPTION OF THE DRAWINGS

The method described here and the device described here are explained in greater detail below on the basis of exemplary embodiments and the associated figures.

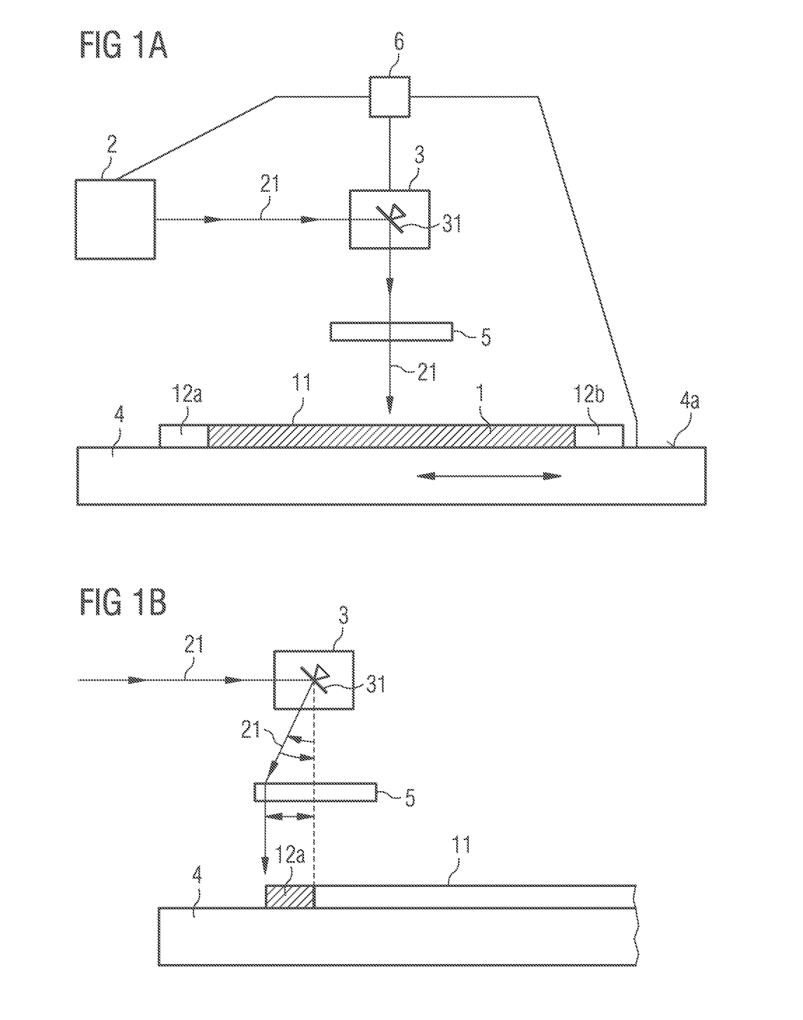

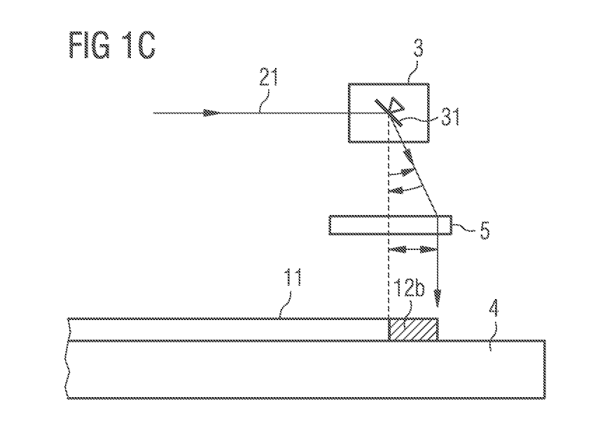

With reference to the schematic sectional illustrations in FIGS. 1A, 1B, 1C, an exemplary embodiment of a method described here, which is carried out by means of an exemplary embodiment of a device described here, is explained in greater detail.

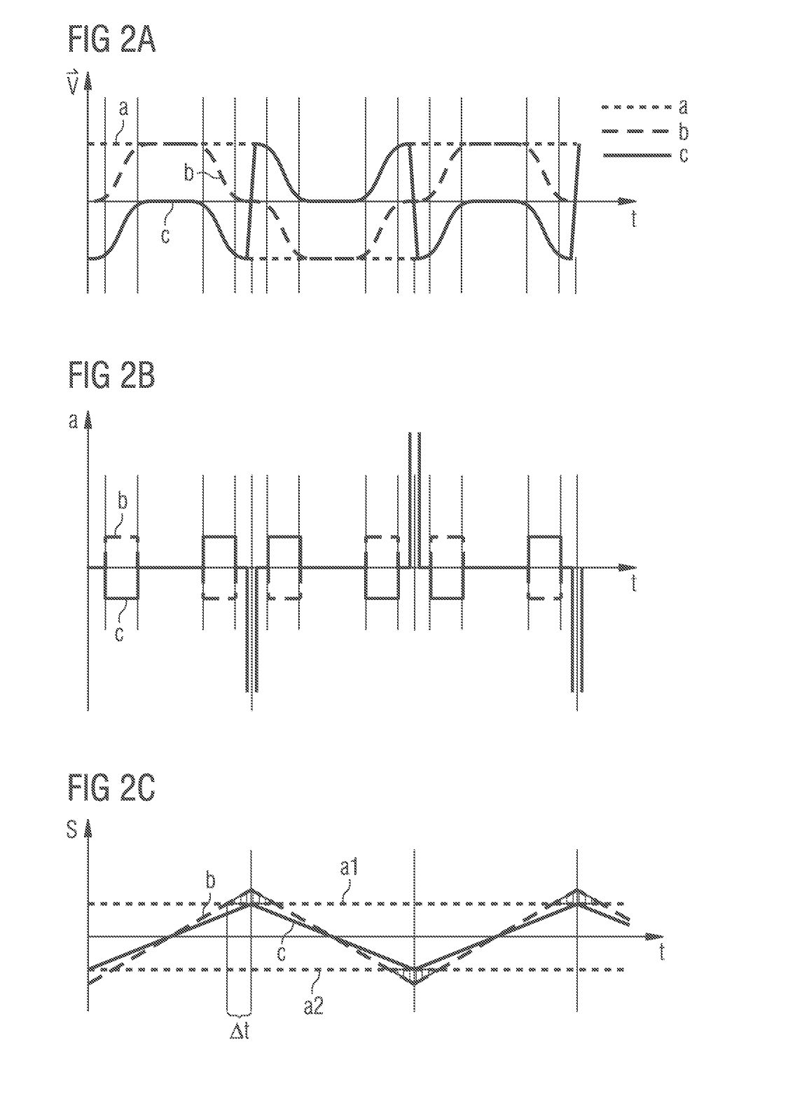

With reference to the graphical plot in FIGS. 2A, 2B, 2C, the method described here is explained in greater detail.

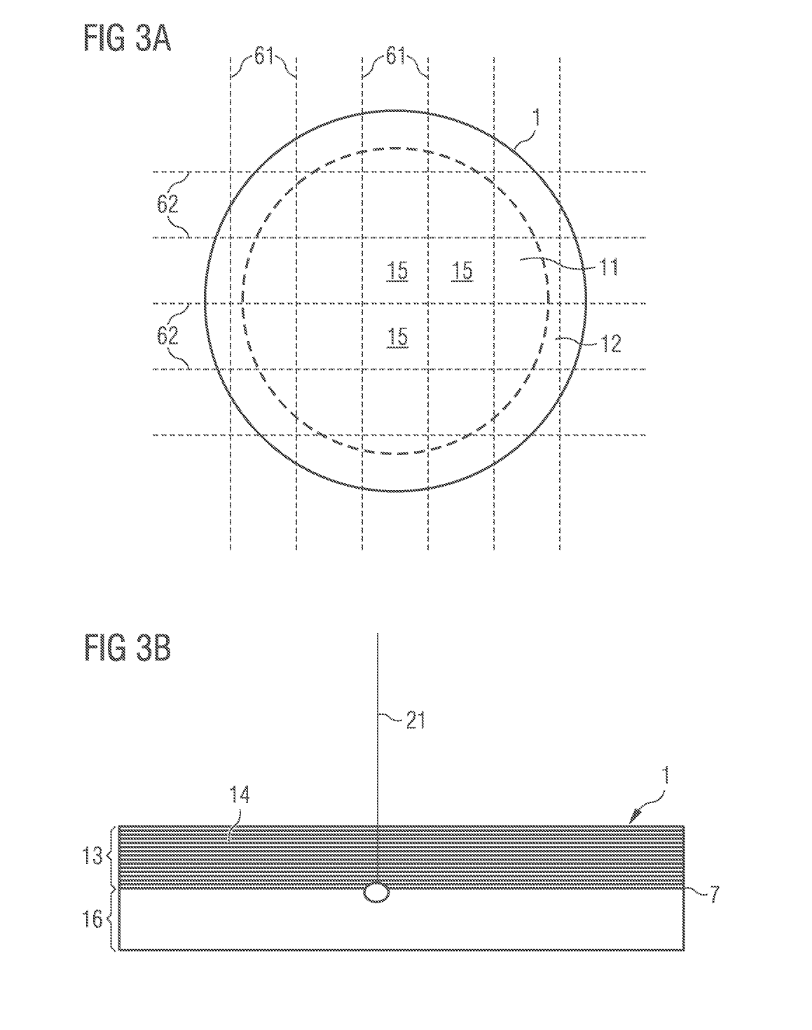

With reference to the schematic illustration in FIGS. 3A and 3B, exemplary embodiments of the method described here are explained in greater detail.

Elements that are identical, of identical type or act identically are provided with the same reference signs in the figures. The figures and the size relationships of the elements illustrated in the figures among one another should not be regarded as to scale. Rather, individual elements may be illustrated with an exaggerated size in order to enable better illustration and/or in order to afford a better understanding.

### DETAILED DESCRIPTION OF ILLUSTRATIVE EMBODIMENTS

FIG. 1A shows a schematic sectional illustration of a device described here. The device comprises a laser source 2. The laser source 2 is, for example, a nanosecond laser or a picosecond laser. The device furthermore comprises an optical device 3, which is, for example, a scanner comprising a movable mirror 31.

The device furthermore comprises a displacing table, which is embodied in movable fashion. In this case, the displacing table can be moved along the arrows depicted. The workpiece 1 is arranged at the top side 4a of the displacing table 4. The workpiece 1 is a semiconductor wafer, for example, which comprises an epitaxially deposited layer sequence 13 comprising at least one active layer 14 (in this respect, also cf. FIG. 3B). The workpiece 1 is subdivided into a central region 11 and an edge region 12. By means of the movement of the displacing table 4, the workpiece 1 is also movable. For this purpose, the workpiece 1 is mechanically firmly fixed to the displacing table 4, which is a “chuck,” for example.

The device furthermore comprises a control device 6. The control device 6 is designed to control the laser 2, the optical device 3 and the displacing table 4.

The device furthermore comprises an optical element 5, which is provided for the beam shaping of the laser beam 21 passing through the optical element. The optical element is an F-theta lens, for example.

During the operation of the device, a laser beam 21 is then generated by the laser 2. The laser beam 21 is directed by the optical device 3 through the optical element 5 onto the top side of the workpiece 1 facing away from the displacing table 4. The workpiece 1 is moved relative to the stationary laser beam 21, in a manner controlled by the control device 6, at constant velocity in one direction, in the present case toward the left edge region 12a in the sectional illustration. Within the central region 11 of the workpiece 1, only the displacing table 4 with the workpiece 1 moves. When the left edge region 12a is reached, the deceleration of the displacing table begins. At the same time, the laser beam 21 is moved by the optical device 3 in a manner controlled by the control device 6, such that the relative velocity between laser beam 21 and workpiece 1 remains identical or substantially identical (in this respect, cf. FIG. 1B). After decelerating and halting, a reversal process takes place within the left edge region 12a, in the case of which during the acceleration of the displacing table 4, the laser beam 21, as also in the case of the decelerating process, is tracked in a manner controlled by the optical device 3 and moved, updated by the control device 6.

After the decelerating and halting and reversal of the workpiece 1, the workpiece 1 is again moved at constant velocity in the central region 11 relative to the stationary laser beam 21. In this case, the reversal process takes place in a manner corresponding to the decelerating process as described above, when the laser beam is then concomitantly moved again upon reaching the right edge region 12b in the sectional illustration (in this respect, cf. FIG. 1C).

The velocity v, the acceleration a and the traversed distance s from the standpoint of the workpiece 1 (curve a), of the displacing table 4 (curve b) and of the laser beam 21 (curve c) are illustrated with reference to the graphical plots in FIGS. 2A, 2B, 2C.

As can be gathered from FIG. 2A, the velocity v of the workpiece 1 relative to the laser beam 21 in one direction remains substantially constant. This is achieved by virtue of the fact that an acceleration and deceleration of the displacing table 4 (curve b) is compensated for by the deceleration and acceleration of the laser beam 21 (curve c) (in this respect, also cf. FIG. 2B).

In FIG. 2C, the area represented in a dashed manner is a measure of the distance saved on account of the concomitant movement of the laser beam 21 by comparison with a completely stationary laser beam 21. This area is therefore also a measure of the saving of process time. In this case, the curves a1 and a2 correspond to the margins of the workpiece 1 in the left edge region 12a and right edge region 12b, respectively.

The separation of a workpiece 1 embodied as a semiconductor wafer into a multiplicity of optoelectronic semiconductor chips 15 is illustrated schematically in conjunction with FIG. 3A. The laser radiation 21 is guided, for example, along the lines 61 and 62 by means of the method. The workpiece 1 is in each case completely severed along said lines. In this case, the thickness of the workpiece is 120 μm, for example. Given a chip width of 295 μm², approximately 90,000 individual optoelectronic semiconductor chips 15 are singulated from the workpiece 1.

With the use of a nanosecond laser as laser 2, the total process duration for this purpose is approximately 28 minutes without movement of the laser beam. In this case, the reversal time takes up a proportion of approximately 16 minutes, and the pure process time is then 12 minutes. No severing can be performed in the reversal time. In this case, the severing is effected by guiding the laser beam with between two and seven repetitions along one of the lines 61, 62 over the workpiece 1.

Using a method described here, that is to say with concomitant movement of the laser beam, the total process time can be reduced to 8 minutes. The reversal time, in which machining by the laser beam is not possible, is just 1 minute, and the process time is shortened to 7 minutes.

The problem of the reversal times becomes particularly serious with the use of a picosecond laser as laser 2. In the case of picosecond lasers, the material removal per pulse is very small on account of the shorter pulse duration. In comparison with the two to seven repetitions per line 61, 62, with the use of a picosecond laser approximately 1200 traverses (that is to say cutting repetitions per line 61, 62) are necessary in order to sever a 120 μm thick semiconductor wafer as workpiece. The total reversal time required by the displacing table 4 to decelerate the velocity, halt and move again in the opposite direction is multiply increased by the number of traverses and is therefore significantly higher with the use of picosecond lasers. Without the method described here, the total process time in the example mentioned is approximately 127 minutes, with 92 minutes being allotted to the reversal time and 35 minutes to the process time. With the use of a method described here, that is to say with the concomitant movement of the laser beam in the edge region, the total process time decreases to 41 minutes, with 21 minutes being allotted to the reversal time and 20 minutes being allotted to the process time. Therefore, the method described here allows the economic use of a picosecond laser, which is additionally distinguished by the improved edge quality during the severing.

A further exemplary embodiment of a method described here is illustrated in conjunction with FIG. 3B. In this exemplary embodiment, the laser beam 21 is used for laser lift-off. That is to say that in a plane 7 defined, for example, by the interface between a substrate 16, for example a growth substrate, and the layer sequence 13 applied, for example epitaxially deposited, onto the substrate 16, the laser sequence 13 is separated from the substrate 16. If the laser beam 21 is in this case guided over the workpiece 1 line by line, the method described here can entail a significant reduction of the process time.

The invention is not restricted to the exemplary embodiments by the description on the basis of said exemplary embodiments. Moreover, the invention encompasses any novel feature and also any combination of features, which in particular includes any combination of features in the patent claims, even if this feature or this combination itself is not explicitly specified in the patent claims or exemplary embodiments.

1-13. (canceled)

14. A method for machining a workpiece, the method comprising:
irradiating the workpiece with a laser beam of a laser;
during irradiation of a central region of the workpiece, keeping the laser beam stationary and moving the workpiece; and
during irradiation of an edge region of the workpiece, moving the laser beam and the workpiece at least intermittently.

15. The method according to claim 14, wherein the relative velocity between laser beam and workpiece during the irradiation of the edge region is at least intermittently equal to the relative velocity between laser beam and workpiece during the irradiation of the central region.

16. The method according to claim 14, wherein the laser is operated in a pulsed fashion, wherein the duration of the pulses is at most 100 ns.

17. The method according to claim 14, wherein the laser is operated in a pulsed fashion, wherein the duration of the pulses is at most 100 ps.

18. The method according to claim 14, wherein material of the workpiece is removed in places during the machining of the workpiece.

19. The method according to claim 14, wherein, during the machining of the workpiece, the workpiece is severed into at least two parts along a line running along a relative movement between laser beam and workpiece.

20. The method according to claim 14, wherein, during the machining of the workpiece, the workpiece is severed into at least two parts along a plane that the laser beam intersects at least in the extension thereof.

21. The method according to claim 14, wherein the workpiece comprises an epitaxially grown layer sequence composed of a semiconductor material.

22. The method according to claim 21, wherein the layer sequence comprises at least one optoelectronic, active layer.

23. The method according to claim 21, wherein, during the machining, the layer sequence is divided into a multiplicity of optoelectronic semiconductor chips.

24. The method according to claim 21, wherein, during the machining, a substrate is detached from the layer sequence.

25. A device for machining a workpiece, the device comprising:
a movable displacing table, to a top side of which the workpiece is to be fixed;
a laser, configured to generate a laser beam that irradiates the workpiece;
an optical device, configured to assist in moving the laser beam relative to the workpiece; and
a control device, wherein the control device is configured to control movement of the laser beam and displacing table in such a way that during irradiation of a central region of the workpiece, the laser beam remains stationary and the workpiece is moved, and, during irradiation of an edge region of the workpiece, the laser beam and the workpiece are moved at least intermittently.

26. The device according to claim 25, wherein the optical device comprises a scanner.

27. A device for machining a workpiece, the device comprising:
a movable displacing table, to a top side of which the workpiece is to be fixed;
a laser, configured to generate a laser beam; and
a control device, programmed to cause the following steps to be performed:
irradiating the workpiece with the laser beam of the laser;
during irradiation of a central region of the workpiece, keeping the laser beam stationary and moving the displacing table; and
during irradiation of an edge region of the workpiece, moving the laser beam and the displacing table at least intermittently.

28. The device according to claim 27, further comprising an optical device, configured to assist in moving the laser beam relative to the workpiece.

29. The device according to claim 28, wherein the optical device comprises a scanner.

30. The device according to claim 27, wherein the relative velocity between laser beam and workpiece during the irradiation of the edge region is at least intermittently equal to the relative velocity between laser beam and workpiece during the irradiation of the central region.

31. The device according to claim 27, wherein the laser is configured to be operated in a pulsed fashion, wherein the duration of the pulses is at most 100 ns.

32. The device according to claim 27, wherein the laser is configured to be operated in a pulsed fashion, wherein the duration of the pulses is at most 100 ps.
